(19) United States
(12) Patent Application Publication
(10) Pub. No.: US 2025/0223998 A1
(43) Pub. Date: Jul. 10, 2025

(54) SHAFT MODULE AND METHOD FOR INSTALLING A SHAFT MODULE

(71) Applicant: Schaeffler Technologies AG & Co. KG, Herzogenaurach (DE)

(72) Inventors: Tony Zeiss, Nürnberg (DE); Brenda Drake, Forchheim (DE)

(73) Assignee: Schaeffler Technologies AG & Co. KG, Herzogenaurach (DE)

(21) Appl. No.: 18/846,877

(22) PCT Filed: Feb. 14, 2023
(86) PCT No.: PCT/DE2023/100122

§ 371 Date: Sep. 13, 2024

(30) Foreign Application Priority Data
Mar. 15, 2022 (DE) 10 2022 105 935.9
Nov. 17, 2022 (DE) 10 2022 130 444.2

(51) Int. Cl. F16C 3/02; F16H 57/00

(52) U.S. Cl. CPC F16C 3/023; F16H 57/0025; F16H 57/0037; F16C 2226/36; F16C 2361/61

(57) ABSTRACT

A shaft module at least having a first tooth system and at least two bearing seats is distinguished in that the first tooth system sits on a hub and is connected to the hub by at least one welded joint, and in that the bearing seats are formed on components separate from the tooth system. At least one of the components and the tooth system are secured on each other by a welded joint.

### CROSS-REFERENCE TO RELATED APPLICATIONS

This application is the U.S. National Phase of PCT Appln. No. PCT/DE2023/100122 filed Feb. 14, 2023, which claims priority to DE 10 2022 105 935.9 filed Mar. 15, 2022 and DE 10 2022 130 444.2 filed Nov. 17, 2022, the entire disclosures of which are incorporated by reference herein.

### TECHNICAL FIELD

The disclosure relates to a shaft module, a method for producing a shaft module, and a transmission device having a shaft module.

### BACKGROUND

EP 3 296 147 A1 discloses a section of a drive train having two shaft modules of the type mentioned. One of the shaft module is formed by a gear wheel shaft on which the shaft and the tooth system are formed in one piece. The tooth system of this shaft meshes with another tooth system of a gear wheel seated on another shaft. This shaft is also designed as a gear wheel shaft, which is integrally provided with a tooth system.

### SUMMARY

One of the key issues in technology today is CO₂ neutrality.

The object of the disclosure is to create a shaft module with which a contribution toward this goal can be made.

This object is achieved according to the subject matter of disclosed herein.

The disclosure is defined by the following features:
a. The shaft module has a tooth system and at least two bearing seats. The tooth system is intended for meshing with at least one gear wheel of a transmission device, preferably a transmission device of a motor vehicle. Bearing seats are zones on components on which rolling bearings act. The shaft module is supported by rolling bearings. Bearing seats optionally provide seats for inner rings or outer rings of sliding or rolling bearings or sliding surfaces or rolling raceways of rolling bearings.
b. A first tooth system is seated on a hub that is designed separately from the tooth system. The hub is a component which extends predominantly in the radial direction and carries the tooth system or connects the tooth system to a bearing seat. Radial is at right angles to the axis of rotation of the shaft module. The axis of rotation of the shaft module runs axially, regardless of the actual position thereof in space.
c. The first tooth system and the hub are connected to each other by at least one welded joint. Welded joints are implemented at specific points or as weld seams with or without the use of additional materials. One variant of such a welded joint is a weld seam running around the axis of rotation.
d. The bearing seats are formed on components separate to the tooth system. Separate components for the tooth system include, for example, shafts, hubs, other tooth systems or gear wheels optionally or in combination.
e. One of the components and the tooth system are connected to each other by at least one welded joint. The tooth systems, components and hub are preferably made of steel, which are connected to each other analogously to c.

Furthermore, it is provided that a welded joint is provided between the end face of a stub shaft and the axial interior of a connecting section within an inner cavity for securing a first component and the first tooth system. To form the inner cavity, it is provided that the first tooth system has a radially extending connecting section on the side opposite the hub. The connecting section further has an axial interior. This interior is positioned opposite the end face of the hub and is axially spaced therefrom. In this way, the cavity is formed radially within the tooth system. It is axially limited by the axial end face on the one hand, and on the other hand the end face of the stub shaft together with the interior of the connecting section.

For this purpose, it can be provided in particular that the stub shaft is brought together with the first tooth system. The radial connecting section of the first tooth system rests radially on the outside of the stub shaft. In principle, the stub shaft itself can also extend axially beyond the interior of the connecting section. In this way, a cavity accessible from the other side is formed in the radial space within the first tooth system, which allows accessibility for a tool such that a welded joint can be made radially between the connecting section and the shaft portion on the interior of the connecting section and the radial exterior of the shaft portion. In this way, this welded joint is located inside the cavity in the final assembled shaft module and is not exposed to any external influences. The second component with the hub can then be inserted into the opening formed by the above connection. The shaft module can be completed by a further weld seam, which is now accessible from the outside, between the first tooth system and the hub of the second component.

In addition, embodiments of the disclosure provide that:
f. One of the components is designed as the hub. The hub is preferably a molded part with a disc-shaped edge and a projection on which is formed at least one bearing seat.
g. The shaft module has a second tooth system. The shaft module is provided with at least two tooth systems, each of which is designed to mesh with at least one gear wheel of a transmission device. The tooth systems are preferably arranged to be coaxial to one another on the axis of rotation. Such a shaft module is advantageously suitable for use as an intermediate shaft in a multi-shaft transmission, or as a multiple planet in a planetary transmission, and is preferably intended for use in vehicles with electric drives or combustion engines. This also applies to hybrid vehicles with combined drives. Due to the internal welded joint between the first tooth system and the first component, the second tooth system can be formed, in particular monolithically, on the outer circumference of the first component in such a way that it lies axially directly on the exterior of the connecting section. On the one hand, a welded joint is no longer necessary on this contact surface and, in one embodiment of the disclosure, is also not provided. The connecting section can then extend in the radial direction, so that the first tooth system in the axial direction substantially directly adjoins the second tooth system without axial spacing. In this way, a very light shaft module with a very short axial extension can be formed.
h. The second tooth system is connected to the first tooth system. The connection of the tooth system is preferably secured by at least one press fit and/or at least one welded joint.
i. One of the components has the second tooth system. The tooth system and at least one of the bearing seats are formed monolithically in one piece in steel. A further development of this embodiment of the disclosure provides that the bearing seat provides a seating surface for the seat of a bearing ring. The bearing ring can be an outer ring, but is preferably an inner ring. An outer ring is provided on the inner circumference with at least one sliding surface or at least one rolling raceway. An inner ring is provided on the outer circumference with at least one sliding surface or rolling raceway. Alternatively, the running surface is formed directly on a pin or shaft extension of one of the components, so that the inner or outer ring can be dispensed with.
j. The tooth systems, the hub, and the bearing seats are designed as a self-supporting unit in the sense that they are directly attached or supported on each other without the need for a supporting shaft as a separate component.
k. At least one tooth system is formed on a hollow gear wheel. The hollow gear wheels are optionally manufactured in a chipless manner as forged parts or as extruded parts. The gear wheels, especially the tooth systems, can then be reworked using machining processes. Gear wheels manufactured using machining processes are also provided. Gear wheels which are manufactured using both non-cutting and machining steps are also provided.
l. At least one of the bearing seats is provided with a raceway for rolling elements of a rolling bearing. This makes it advantageous to dispense with a bearing ring for cost and/or space reasons.

Overall, an inner cavity is formed by the axial interiors or end faces of the components involved, i.e., the two gear wheels and the hub. Within the cavity, there is no axial overlap of the components involved. The tooth system of first gear wheel is located radially outside the cavity. The first gear wheel has a radial thickness in the region of the cavity which is preferably smaller than the radial extension of the hub.

The disclosure further provides a transmission device with a shaft module according to the features a.-e., which is optionally designed at the same time according to one of the features f.-l. or according to a combination of these features f.-l.
m. Transmission device in which the shaft module is mounted in a housing by means of at least two rolling bearings supported via the bearing seats.

The disclosure further provides a method for producing a shaft module, with which the tooth systems and the hub are assembled to form a self-supporting structural unit and secured on each other by welded joints.

The advantage of the disclosure is that a shaft as a supporting component can be dispensed with in such arrangements. The weight of the gear wheel module is therefore lower compared to the gear wheel modules from the prior art. In addition, the use of hollow gear wheels supported by hubs reduces the overall weight of the gear wheel module. Less material is needed in production. The components can be manufactured easily and cost-effectively. Overall, stimulated by the reduced weight and simplified production of such a gear wheel module, such a solution will contribute to the achievement of a CO₂ reduction.

### BRIEF DESCRIPTION OF THE DRAWINGS

The disclosure is explained in more detail below with reference to an exemplary embodiment.

In the drawings:

FIG. 1—shows a shaft module 1 in a longitudinal section along an axis of rotation 18,

FIG. 2—shows a shaft module 1 according to FIG. 1 as a structural unit with rolling bearings 6 and 7,

FIG. 3—shows a section of a transmission device 20 with the gear wheel module 1.

### DETAILED DESCRIPTION

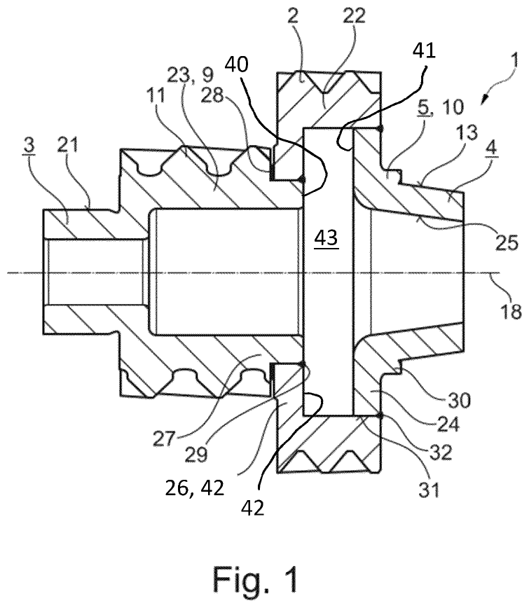

FIG. 1—The shaft module 1 has a first tooth system 2, a second tooth system 11, a hub 5, and two bearing seats 3 and 4.

The first tooth system 2 is formed on an internally hollow first gear wheel 22. The second tooth system 11 is formed on an internally hollow second gear wheel 23. The first tooth system 22 is designed as helical tooth system and is formed on the first gear wheel 22, which is designed as a ring gear with external tooth system. A connecting section 26 of the gear wheel 22 extends radially from the ring gear in the direction of the axis of rotation 18 and encircles the axis of rotation 18, which connecting section is designed as a single piece and made of one material with the first gear wheel 22, but can alternatively also be a separate component.

The second tooth system 11 on the internally hollow second gear wheel 23 is designed as a helical tooth system. The second tooth system 11 is followed by a stub shaft 27 directed in the direction of the bearing seat 4 and formed as a single piece with the second gear wheel 23, on which the first gear wheel 22 is centered and supported via the connecting section 26. A bearing seat 3 in the form of a hollow cylindrical pin is formed monolithically in one piece with the second gear wheel 23 and has an outer cylindrical surface 21.

The hub 5 is provided with a bearing seat 4 and has a radial flange 24. The bearing seat 4 is substantially conical and has an internally conical surface 25. An externally conical raceway 13 is formed on the outer circumference of the bearing seat 4. The raceway 13 is followed by a shoulder 30 in the direction of the flange 24.

The first gear wheel 22, the second gear wheel 23 and the hub 5 are formed into an internally hollow and self-supporting structural unit of the shaft module 1. The hub 5 is a component 10 to which the first tooth system 2 is connected. The first gear wheel 22 is centered on the outside on an external cylindrical surface 31 of the flange 24 and is fastened there with the aid of a welded joint 32. The second gear wheel 23 is a component 9 to which the first gear wheel 22 or the first tooth system 2 are connected. The first gear wheel 22 and the second gear wheel 23 are optionally connected to one another by means of a welded joint 28 and/or preferably the welded joint 29. The welded joints 28, 29, and 32 can alternatively be formed from one or more welding zones/points that follow one another at a radial distance from and circumferentially around the axis of rotation 18, or from ring welds that run circumferentially around the axis of rotation 18. Alternatively, one of the components can also be the connecting section 26, which is alternatively connected to the second gear wheel and/or the first gear wheel via one of the variants of welded joints.

When assembling the first tooth system 2 with the components 9 and 10 to form the shaft module 1, the first gear wheel 22 is connected to the second gear wheel 23 in a first step by pushing or pressing the first gear wheel 22 onto the stub shaft 27 via the connecting section 26 and thus centering it to the axis of rotation 18. In a second step, the first gear wheel 22 and the first component 9 are fastened or secured on each other via at least one welded joint 28 or 29. In a next step, the hub 5 is then inserted or pressed into the first tooth system 2 and fastened or secured there by means of a welded joint 32.

The stub shaft 27 projects axially into the radially inner region of the first gear wheel 22. The stub shaft (27) further has an axial end face 40. The first gear wheel 22 has a first hub 5 and a second hub 44, here formed by the connecting section 26. The axial interiors 41, 42 of the two hubs 5, 44 are spaced apart from each other so that a hollow interior space or cavity 43 is formed radially within the tooth system 2.

The end face 40 of the stub shaft 27 has an axial position so that it does not protrude axially into the cavity 43 and is axially flush with the axial interior 40 of the connecting section 26.

Overall, an inner cavity 43 is formed by the axial interiors 41, 42 and end faces 40 of the components involved, i.e., the two gear wheels 22, 23 and the hub 5. Within the cavity 43 there is no axial overlap of the components involved. The tooth system of the first gear wheel 22 is located radially outside the cavity 43. The first gear wheel 22 has a radial thickness in the region of the cavity 43 which is smaller than the radial extension of the hub 5.

Apart from the stub shaft 27 and the axial extension of the connecting section 26, there are no overlapping areas between the two gear wheels 22, 23. In particular, no parts of the other assemblies involved are provided radially within one of the tooth systems 2 and 11.

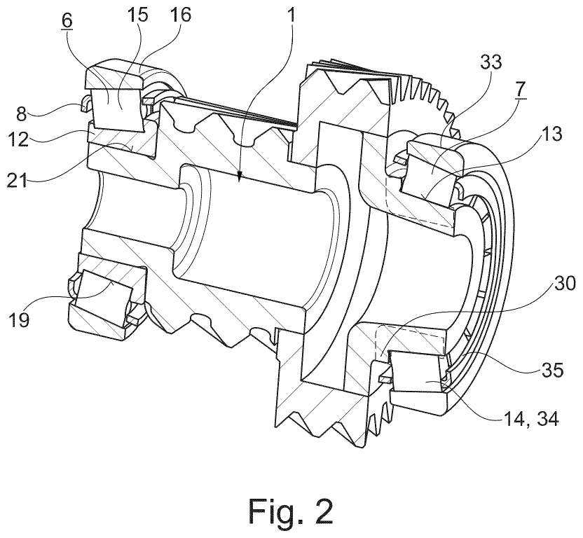

FIG. 2—The shaft module 1 can be provided as a structural unit with the rolling bearings 6 and 7. The rolling bearing 6 is a tapered roller bearing with an inner ring 12, tapered rollers 15, a cage 8 and an outer ring 16. The inner ring 12 is seated on the outside of the outer cylindrical surface 21 and has a raceway 19 for the tapered rollers 15 on the outer circumference. The rolling bearing 7 is also a tapered roller bearing with an outer ring 33, with rolling elements 14 designed as tapered rollers 34 and with a cage 35, one raceway for the tapered rollers 34, however, is formed directly on the bearing seat 4 as the conical raceway 13. The shoulder 30 replaces a rib as is usually provided on inner rings of tapered roller bearings.

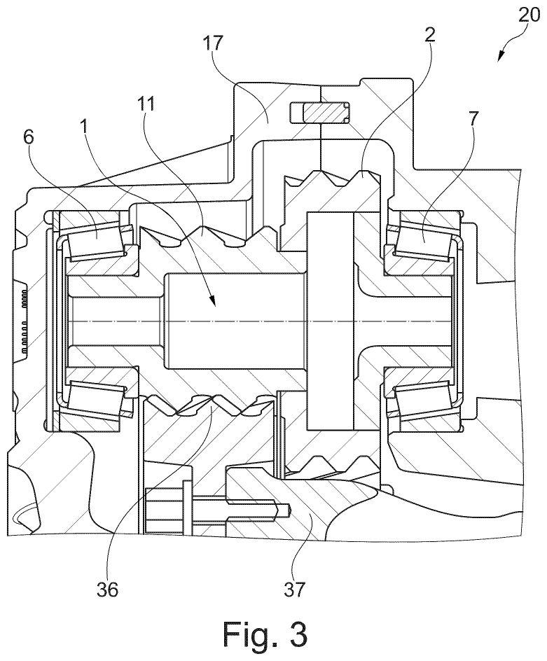

FIG. 3—The transmission device 20 has a housing 17 in which the shaft module 1 is mounted by means of the rolling bearings 6 and 7. A tooth mesh of the first tooth system 2 is concealed in the view and therefore not visible. The second tooth system 11 is in meshing engagement, for example, with a tooth system 36 on a differential cage 37 of a differential not shown in detail.

### LIST OF REFERENCE SYMBOLS

1 Shaft module
2 First tooth system
3 First bearing seat
4 Second bearing seat
5 Hub
6 Rolling bearing
7 Rolling bearing
8 Cage
9 Component
10 Component
11 Second tooth system
12 Inner ring
13 Raceway
14 Rolling element
15 Tapered rollers
16 Outer ring
17 Housing
18 Axis of rotation
19 Raceway
20 Transmission device
21 External cylindrical surface
22 First gear wheel
23 Second gear wheel
24 Flange
25 Internal conical surface
26 Connecting section
27 Stub shaft
28 Welded joint
29 Welded joint
30 Shoulder
31 External cylindrical surface
32 Welded joint
33 Outer ring
34 Tapered roller
35 Cage
36 Tooth system
37 Differential cage
40 End face
41 End face
42 Interior
43 Cavity

1. A shaft module comprising:
at least one first tooth system and at least two bearing seats, the first tooth system being seated on a hub and being connected to the hub by at least one welded joint, the first hub having an axial end face, and the bearing seats being formed on components separate from the tooth system, at least one of the components, and the first tooth system being secured on each other by a welded joint, wherein:
the first component has an axially extending stub shaft with an axial end face,
the first tooth system has a radially extending connecting section on the side opposite the hub,
the connecting section has an axial interior, which the end face of the hub is opposite and axially spaced from it, so that an inner cavity is formed radially within the tooth system and axially through the axial end face on the one hand, and on the other hand on the end face of the stub shaft and the interior of the connecting section,
wherein the welded joint between the end face of the stub shaft and the axial interior of the connecting section is provided within the inner cavity for securing the first component and the first tooth system.

2. The shaft module according to claim 1, wherein a second tooth system is connected to the first tooth system.

3. The shaft module according to claim 2, wherein a first bearing seat of the bearing seats is formed monolithically in one piece with the second tooth system.

4. The shaft module according to claim 1, wherein a second component of the components is designed as the hub and the second tooth system is a further first component of the components.

5. The shaft module according to claim 1, wherein the end face of the stub shaft terminates axially with the interior of the connecting section.

6. The shaft module according to claim 5, wherein the tooth systems, the hub, and the bearing seats are designed as a self-supporting structural unit to the shaft module.

7. The shaft module according to claim 1, wherein at least one tooth system is formed on an at least partially hollow gear wheel.

8. The shaft module according to claim 1, wherein at least one bearing seat of the bearing seats is provided with a raceway for rolling elements of a rolling bearing.

9. A transmission device having a shaft module according to claim 1, in which the shaft module is mounted in a housing by means of at least two rolling bearings supported via the bearing seats.

10. A method for producing a shaft module according to claim 6, with which the tooth systems and the hub are assembled to form a self-supporting structural unit and secured on each other by welded joints.
